(19) United States
(12) Patent Application Publication
(10) Pub. No.: US 2026/0170725 A1
(43) Pub. Date: Jun. 18, 2026

(54) SYSTEM AND METHOD FOR MACHINE-LEARNING BASED MODIFICATION OF USER IMAGES BASED ON REFERENCE IMAGE OR GRAPHICAL AVATAR

(71) Applicant: L'Oreal, Paris (FR)

(72) Inventor: Mick Anthony YOON, Brooklyn, NY (US)

(73) Assignee: L'Oreal, Paris (FR)

(21) Appl. No.: 18/986,436

(22) Filed: Dec. 18, 2024

(51) Int. Cl. G06T 11/60; G06T 7/40; G06T 7/90; G06T 11/00

(52) U.S. Cl. CPC G06T 11/60; G06T 7/40; G06T 7/90; G06T 11/10; G06T 2200/24; G06T 2207/10024; G06T 2207/20081; G06T 2207/30201

(57) ABSTRACT

A computer system extracts, by a reference analysis engine, one or more reference attributes of a reference image or graphical avatar; extracts, by a user image analysis engine, one or more target attributes of a target user image; executes a machine learning model using the one or more reference attributes and the one or more target attributes as input to generate target image modification data as output; and generates, by a virtual try-on engine, a modified version of the target user image based on the target image modification data generated by the machine learning model.

### SUMMARY

In one aspect, a computer system extracts, by a reference analysis engine, one or more reference attributes of a reference image or graphical avatar; extracts, by a user image analysis engine, one or more target attributes of a target user image; executes a machine learning model using the one or more reference attributes and the one or more target attributes as input to generate target image modification data as output; and generates, by a virtual try-on engine, a modified version of the target user image based on the target image modification data generated by the machine learning model.

In some embodiments, the machine learning model is trained on a training set of modified user images using a supervised learning approach. In some embodiments, the training set of modified user images is labeled with corresponding avatar attributes. In some embodiments, the one or more reference attributes comprise a first set of hexadecimal color values, and wherein the target image modification data generated by the machine learning model comprises a second set of hexadecimal color values.

In some embodiments, the one or more reference attributes comprise one or more hair color values of a graphical avatar. In some embodiments, the machine learning model uses the one or more hair color values of the graphical avatar as input to generate the target image modification data. In some embodiments, the target image modification data comprises one or more modified hair color values for the target user image.

In some embodiments, the one or more reference attributes comprise a face color value of the reference image or graphical avatar. In some embodiments, generating the modified version of the target user image comprises modifying a face area of the target user image based on the face color value of the reference image or graphical avatar. In some embodiments, the modified version of the target user image includes a depiction of a virtual cosmetic applied to the modified face area of the target user image. In some embodiments, a color of the virtual cosmetic corresponds to the face color value of the reference image or graphical avatar.

In some embodiments, the one or more reference attributes comprise a texture value of the reference image or graphical avatar. In some embodiments, the computer system executes a machine learning model using the texture value of the reference image or graphical avatar as input to generate target image texture modification data as output; and using a virtual try-on engine, further modifies the target user image based on the target image texture modification data by modifying a face area of the target user image based on the target image texture modification data. In some embodiments, the modified face area of the target user image includes a depiction of a virtual cosmetic applied to the modified face area of the target user image. In some embodiments, the depicted virtual cosmetic having a texture or finish based on the target image texture modification data.

In some embodiments, the one or more reference attributes of the reference image or graphical avatar comprise length, texture, or style of hair of the reference image or graphical avatar. In some embodiments, the computer system executes a machine learning model using the length, texture, or style of the hair of the reference image or graphical avatar as input to generate target image hair modification data as output. In some embodiments, the computer system uses a virtual try-on engine to further modify the target user image based on the target image hair modification data.

In some embodiments, the one or more reference attributes of the reference image or graphical avatar comprise length, density, color, or texture of eyelashes of the reference image or graphical avatar. In some embodiments, the computer system executes a machine learning model using the length, density, color, or texture of eyelashes of the reference image or graphical avatar as input to generate target image eyelash modification data as output. In some embodiments, the computer system uses a virtual try-on engine to further modify the target user image based on the target image eyelash modification data.

In some embodiments, the computer system presents in a user interface a product or style recommendation based on the one or more reference attributes, the target image modification data, the modified version of the target user image, or a combination thereof.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### BRIEF DESCRIPTION OF THE DRAWINGS

The foregoing aspects and many of the attendant advantages of the disclosed subject matter will become more readily appreciated as the same become better understood by reference to the following detailed description, when taken in conjunction with the accompanying drawings, wherein:

FIG. 1A is a schematic illustration that illustrates a system for automated, machine-learning based avatar customization based on one or more user images, according to various aspects of the present disclosure;

FIG. 1B is a schematic illustration that illustrates a system for automated, machine-learning based virtual try-on or recommendations based on avatars or other digital content, according to various aspects of the present disclosure;

FIG. 2 is a block diagram that illustrates a computer system in which various aspects of the present disclosure may be implemented;

FIG. 3 is a block diagram that illustrates an example embodiment of a client computing device according to various aspects of the present disclosure;

FIG. 4 is a flowchart that illustrates an example embodiment of a method of machine-learning based modification of a graphical avatar based on attributes of a user image;

FIG. 5 is a flowchart that illustrates an example embodiment of a method of machine-learning based modification of a user image based on a reference image or graphical avatar; and

FIG. 6 is a block diagram that illustrates aspects of an exemplary computing device appropriate for use as a computing device of the present disclosure.

### DETAILED DESCRIPTION

Digital spaces and personal beauty routines are increasingly connected in many ways. For example, social media users often find images of celebrities, friends, animated characters, etc. with desirable traits (e.g., cosmetics, hair color, styling, etc.) that those users would like to apply to their own appearance. As another example, users may have online personas represented by avatars or other digital representations. To personalize an avatar, a user may wish to customize it with some new aspect of their own look, such as a new cosmetic, hair color, or styling.

However, it is difficult for users, from a technical perspective, to apply looks from other sources to a user's own likeness in an accurate way. Existing tools may allow a user to modify their own image using image filters or editing tools, but such tools have limited options for customization, such as limited color options that must be manually selected from a limited set of predetermined color palettes. It is also difficult for users, from a technical perspective, to apply their own looks to such an avatar in an accurate way. Existing avatar customization tools, such as in video games, may allow a user to modify, e.g., hair color, eye color, skin tone, and the like of an avatar as desired by a user (e.g., via a user interface with color selection or other tools), but such tools also have limited options for customization, such as limited color options or hair styles that must be manually selected from a limited set of predetermined options. If an automated approach is attempted, and even if the number of customizations options were expanded, the ability to obtain good matches remains as a technical problem. A typical approach for mapping a source color in one image to a target color in another image (e.g., lookup tables or hash tables) is not flexible, and in large universes of available colors or other values, such an approach may result in impractically large or unwieldy data structures.

Embodiments described herein provide technical solutions to one or more of the technical problems described above, or other technical problems. In some embodiments, machine learning is used to evaluate makeup looks in virtual spaces and identify products that can help achieve the same look, or to transpose real-life looks to avatars or other digital representations. Shade match technology can be used to calibrate recommended products to a user's skin tone, and geometric face mapping can be used to transpose a desired look from a source such as an avatar or reference image to a target user image. Desired looks can then be applied to a user's image to enable “instant try-on” functionality in a client application. Such an application may include additional features such as product recommendations or tutorials, which may be adjusted to a user's skill level in cosmetics (e.g., simple, moderate, or expert versions). In some embodiments, desired looks can be extracted from any digital medium (e.g., images, movies, games, etc.), a product match can be made based on the user's attributes such as skin tone, and an accurate representation of how the consumer would look with that product applied. In some embodiments, tailored product matching can be used to drastically reduce product search time for users to achieve captured looks. In some embodiments, a geometric face map (e.g., a 2D representation or a 3D representation, such as a polygon mesh) can be generated to identify contours of both the captured look and the user's face, an provide an appropriate representation, with transposition to the user's unique facial geometry. In some embodiments, an augmented reality (AR) approach can be used to overlay representations of captured looks on a live image of the user's face.

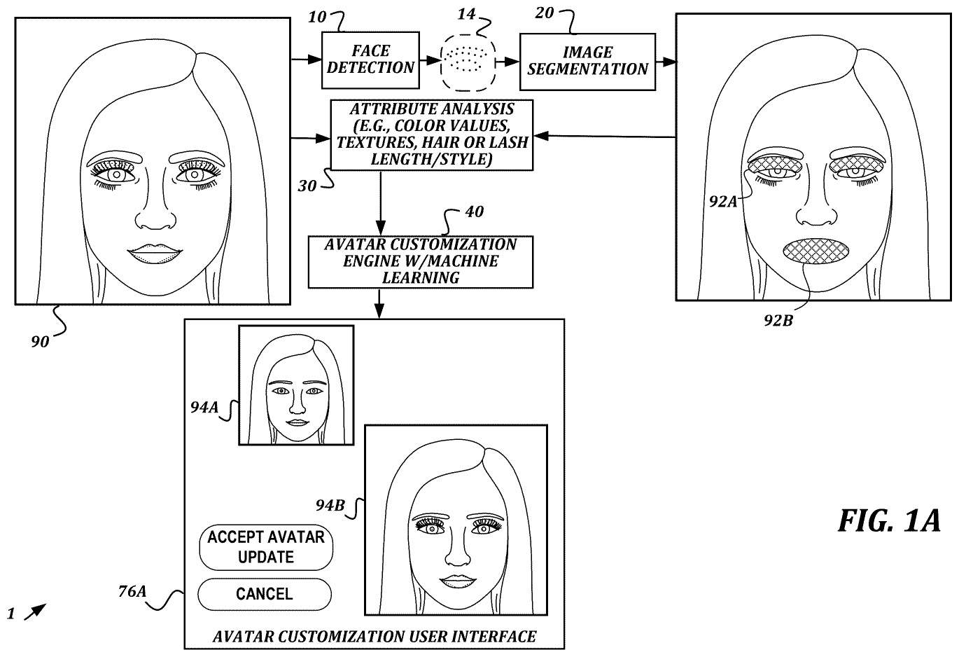

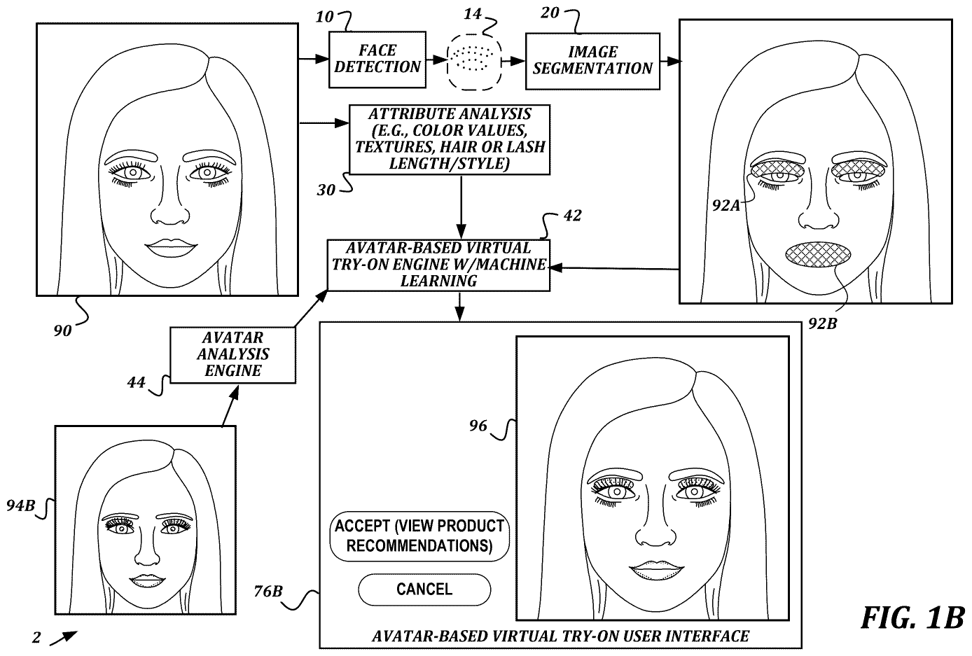

FIG. 1A is a schematic illustration of a non-limiting example embodiment of a system 1 for automated, machine-learning based avatar customization based on one or more user images, according to various aspects of the present disclosure. In some embodiments, components of system 1 are implemented by a client computer device, a server computer system, or a combination thereof.

In the example shown in FIG. 1A, a user image is used as a reference for avatar customization. As shown, reference image data in the form of user image 90 is provided to face detection module 10, which detects a face in the user image. User image 90 depicts a user with applied cosmetics such as lipstick applied in a lip area and eyeshadow applied in the upper eyelid areas. User image 90 is used as a reference for customization of a target in the form of avatar 94A.

Face detection module 10 provides facial feature information to image segmentation module 20, which calculates one or more regions in user image 90 in which corresponding image information (e.g., pixel information) is to be analyzed for avatar customization. In an illustrative implementation, face detection module 10 comprises machine-learning (ML)-based face detection, such as the face detection application programming interface (API) for ML Kit, available from Google LLC.

In the example shown in FIG. 1A, the facial feature information includes a set of facial landmarks 14 (e.g., points or contours corresponding to eyelids, eyelashes, eyebrows, lips, hair, or the like), and may include additional information such as color, 3D depth information, polygon mesh models, or the like to identify facial features and structures. Image segmentation module 20 uses facial landmarks 14 to calculate one or more image regions 92A, 92B, which correspond to boundaries of one or more areas to be analyzed for potential avatar customization (e.g., upper lids and lips). For example, image segmentation module 20 may use facial landmarks 14 to identify an area between a lower boundary of an eyebrow and an upper eyelid as an eyelash and/or eyeshadow region. In the example shown in FIG. 1A, image region 92A corresponds to a left upper eyelash region and a right upper eyelash region depicted in user image 90, whereas image region 92B corresponds to a mouth/lip region.

Image regions may be analyzed using a variety of approaches. As an example, a user may select regions to be analyzed based on preferences. In this situation, the user may select from a list of possible regions (e.g., lips, eyelids, hair, cheeks, eyebrows) to identify areas of interest for potential avatar customizations, such as where the user wishes to update their avatar based on cosmetics the user has applied to the eye and lip areas, while ignoring other areas such as the nose area. As another example, regions may be selected automatically, such as by detecting regions that have changed in appearance (e.g., change in color or texture) relative to a baseline image captured at a previous point in time. As another example, regions may be selected using a combination of user preference and automated approaches. In this situation, the user may select regions to be ignored despite any changes in color or texture (such as the nose and cheek areas, where the user may experience acne breakouts), while allowing automatic selection of regions in other areas, such as hair, eyes, and lips, where detected style, color, or texture changes are more likely to be intentional.

Thus, as an example, image regions 92A, 92B may be selected for analysis for avatar customization based on user selection (e.g., using a drop-down list of options or using graphical selection tools (e.g., lasso, bounding box, or pointer tools) to select areas of interest directly on the image) or on an automatically detected change in color and/or texture relative to a baseline image due to, e.g., application of eyeshadow, eyelash extensions, or lipstick in those regions. Automatic detection of changes may be performed using computer vision techniques, e.g., comparing pixel groups in specified areas of corresponding images, after accounting for other variations in between the images, such as lighting conditions or viewing angle.

In some embodiments, system 1 performs facial attribute analysis of facial features to determine features for reproduction in a customized avatar (e.g., cosmetics, hair color, eyelash extensions, or the like). In the example shown in FIG. 1A, attribute analysis module 30 identifies one or more facial attributes of the subject of the image (e.g., color values, textures, hair length, eyelash length, eyelash density, etc.) and provides the attribute(s) to avatar customization engine 40, which generates one or more avatar customizations using machine learning based at least in part on the identified facial attributes. In some embodiments, facial attributes considered by the avatar customization engine in generating avatar customizations include one or more of cosmetic attributes (e.g., color, texture, finish), eye attributes (e.g., shape, size, color), eyebrow attributes (e.g., shape, size, color, density, texture), skin tone attributes, skin texture attributes (e.g., wrinkles, firmness), skin condition attributes (e.g., blemishes, dryness, oiliness, redness), hair attributes (e.g., color, texture, length). In some embodiments, ML-based avatar customizations (e.g., using an artificial neural network approach) may be used to simulate one or more of a user's attributes in one or more regions.

Different machine learning approaches can be used by avatar customization engine 40. In some embodiments, avatar customization engine 40 uses a supervised learning approach (e.g., using artificial neural networks). In an illustrative scenario, avatar customization engine 40 is trained using training images of various users that are labeled with corresponding avatar customization information (e.g., hair color, lip color, eyelash configurations, etc.). The labels corresponding to the avatar looks may be quantified by, e.g., assigning particular color values or contours to avatar features such as lips, hair, eyelids, eyelashes, etc. In an illustrative operation, avatar customization engine 40 takes color values (e.g., hexadecimal color values in an RGB or other color space) obtained from a user image (e.g., by random sampling or by sampling from predetermined locations, such as particular facial/head features) as input and generates avatar customization data as output. Alternatively, avatar customization engine 40 uses a different approach, such as an unsupervised learning or reinforcement learning approach. For example, a reinforcement learning algorithm may be used that seeks to maximize a reward measured in terms of user ratings where, in a training phase, users are solicited (e.g., in a social network environment) to rate the best or most accurate avatar representation of a real-life image. In such an approach, the system may be trained to select an avatar customization (e.g., set of color values, textures, etc.) that the system predicts will maximize the user ratings.

In some embodiments, system 1 presents avatar customizations in a user interface to allow a user to approve or reject the customizations, or to provide options for further modifications. In the example shown in FIG. 1A, system 1 provides an avatar customization preview 94B that modifies an existing avatar 94A and is available to be accepted or not by a user via user interface 76A (e.g., on a smartphone display or a display of some other client computing device). In this example, avatar customization preview 94B includes changes to the lip area and the upper eyelid area of each eye, including addition of eyelashes and coloring corresponding to lipstick and eyeshadow applied in user image 90, which are not present in existing avatar 94A. Although the example shown in FIG. 1A includes only options to accept or cancel an avatar update for ease of illustration, in some embodiments further options are provided, such as the ability to accept some changes and reject others. In an illustrative scenario, the user is provided with an option to individually accept or reject changes to, say, the eye and lip areas depending on whether the user finds the individual changes to be desirable.

FIG. 1B is a schematic illustration of a non-limiting example embodiment of a system 2 for automated, machine-learning based virtual try-on or recommendations based on avatars or other digital content, according to various aspects of the present disclosure. In some embodiments, components of system 2 are implemented by a client computer device, a server computer system, or a combination thereof.

In the example shown in FIG. 1B, a graphical avatar or digital image is used a reference for modification of a target image (e.g., modification of a user image in a virtual try-on application) and/or product or style recommendations. As shown, a reference analysis engine in the form of avatar analysis engine 44 extracts reference attributes from a reference in the form of avatar 94B. A target image modification engine in the form of avatar-based virtual try-on engine 42 modifies a target image in the form of user image 90 based on the extracted reference attributes.

Target digital image data in the form of user image 90 is provided to face detection module 10, which detects a face in the user image. Face detection module 10 provides facial feature information to image segmentation module 20, which calculates one or more regions in user image 90 in which corresponding image information (e.g., pixel information) is to be analyzed for potential modification or enhancement, e.g., in a virtual try-on application. In an illustrative implementation, face detection module 10 comprises machine-learning (ML)-based face detection, such as the face detection application programming interface (API) for ML Kit, available from Google LLC.

In the example shown in FIG. 1B, the facial feature information includes a set of facial landmarks 14 (e.g., points or contours corresponding to eyelids, eyelashes, eyebrows, lips, hair, or the like), and may include additional information such as color, 3D depth information, polygon mesh models, or the like to identify facial features and structures. In some embodiments, image segmentation module 20 uses facial landmarks 14 to calculate one or more image regions 92A, 92B, which correspond to boundaries of one or more areas to be analyzed for modification or enhancement, e.g., in a virtual try-on application. For example, image segmentation module 20 may use facial landmarks 14 to identify an area between a lower boundary of an eyebrow and an upper eyelid as an eyelash and/or eyeshadow region. In the example shown in FIG. 1B, image region 92A corresponds to a left upper eyelash region and a right upper eyelash region depicted in user image 90, whereas image region 92B corresponds to a mouth/lip region.

Image regions may be analyzed using a variety of approaches. As an example, a user may select regions to be analyzed based on preferences. In this situation, the user may select from a list of possible regions (e.g., lips, eyelids, hair, cheeks, eyebrows) to identify areas of interest for potential modification or enhancement, such as where the user wishes to update their look with cosmetics in the eye and lip areas based on a corresponding look in a digital avatar. As another example, regions may be selected automatically, such as by detecting regions in an avatar that have changed in appearance (e.g., change in color or texture) relative to a baseline image or avatar state captured at a previous point in time. As another example, regions may be selected using a combination of user preference and automated approaches. In this situation, the user may select regions to be ignored despite detected changes, while allowing automatic selection of regions in other areas, such as hair, eyes, and lips.

Thus, as an example, image regions 92A, 92B may be selected for potential updates based on user selection (e.g., using a drop-down list of options or using graphical selection tools (e.g., lasso, bounding box, or pointer tools) to select areas of interest directly on the image) or on an automatically change relative to a baseline image due to, e.g., depictions of eyeshadow, eyelash extensions, or lipstick in corresponding regions of an avatar.

In some embodiments, system 2 performs facial attribute analysis of facial features of a target image to determine features for potential modification or enhancement (e.g., virtual try-on of cosmetics, hair color, eyelash extensions, or the like). In the example shown in FIG. 1B, attribute analysis module 30 extracts one or more target attributes of the subject of the user image 90 (e.g., color values, textures, hair length, eyelash length, eyelash density, etc.) and provides the extracted target attribute(s) to avatar-based virtual try-on engine 42, which generates one or more image modifications or enhancements using machine learning, based at least in part on the extracted target attributes. In some embodiments, target attributes considered by the avatar-based virtual try-on engine 42 include one or more of eye attributes (e.g., shape, size, color), eyebrow attributes (e.g., shape, size, color, density, texture), skin tone attributes, skin texture attributes (e.g., wrinkles, firmness), skin condition attributes (e.g., blemishes, dryness, oiliness, redness), hair attributes (e.g., color, texture, length).

In some embodiments, ML-based image modifications or enhancements (e.g., using an artificial neural network approach) may be used to simulate one or more of a reference's attributes in one or more regions of a target image (e.g., user image 90). As shown in FIG. 1B, reference attributes of avatar 94B (which is used as the reference in this example) are extracted by avatar analysis engine 44. Such attributes may include, e.g., reference color values or contours corresponding to avatar features such as lips, hair, eyelids, eyelashes, etc. Alternatively, aside from avatars, other digital images (such as images of animated characters, celebrities, social media influencers, artworks, landscapes, products, logos, sports team uniforms, etc.) may be used as references and analyzed to extract attributes (e.g., color schemes) for user image modifications or enhancements.

Different machine learning approaches can be used by a virtual try-on engine. In some embodiments, a virtual try-on engine uses a supervised learning approach (e.g., using artificial neural networks). In an illustrative scenario, a virtual try-on engine is trained using modified user images as training data, the modified user images being labeled with corresponding avatar information (e.g., hair color, lip color, eyelash configurations, etc.) that was used to modify the user images. The labels corresponding to the avatar looks may be quantified by, e.g., particular modified color values or modified contours corresponding to extracted avatar features such as lips, hair, eyelids, eyelashes, etc. In an illustrative operation, avatar-based virtual try-on engine 42 takes reference attributes provided by avatar analysis engine 44 and target attributes of a user image as input and generates target image modification data (e.g., modified color values, modified contours, modified texture data, etc.) as output. Target attributes of the user image may include, for example, hexadecimal color values in an RGB or other color space, which may be obtained from a user image by random sampling or by sampling from predetermined locations, such as particular facial/head features. Alternatively, a virtual try-on engine uses a different approach, such as an unsupervised learning or reinforcement learning approach. For example, a reinforcement learning algorithm may be used that seeks to maximize a reward measured in terms of user ratings where, in a training phase, users are solicited (e.g., in a social network environment) to rate the best or most accurate representation of avatar attributes in modified user image. In such an approach, the system may be trained to select a modification or enhancement of a user image (e.g., set of color values, textures, etc.) that the system predicts will maximize the user ratings.

In some embodiments, system 2 presents user image modifications or enhancements in a virtual try-on user interface to allow a user to approve or reject the modifications or enhancements, to view corresponding product or care routine recommendations to achieve the corresponding look, or to provide options for further modifications. In the example shown in FIG. 1B, system 2 provides virtual try-on image 96 with modifications that are available to be accepted or not by a user via user interface 76B (e.g., on a smartphone display or a display of some other client computing device). In this example, virtual try-on image 96 includes changes to the lip area and the upper eyelid area of each eye of user image 90, including addition of eyelashes and coloring corresponding to lipstick and eyeshadow applied in user image 90. These changes correspond to features in avatar 94B that have been extracted by avatar analysis engine 44. In some embodiments, an augmented reality (AR) approach can be used to overlay proposed or accepted changes relating to representations of captured looks on a live image of the user's face.

Although the example shown in FIG. 1B includes only options for accepting, viewing product recommendations, or canceling for ease of illustration, in some embodiments other options are provided, such as the ability to accept or view some changes or product recommendations and reject others. In an illustrative scenario, the user is provided with an option to individually accept and view product recommendations for, say, eyeshadow, eyelash extensions, and lipstick for the eye and lip areas depending on whether the user finds the individual changes to be desirable.

In some embodiments, product recommendations are predetermined based on avatar features. For example, avatars may be customized to promote particular products, with the avatars being depicted as wearing the particular products. In this situation, product recommendations may be automatically generated based on the promoted products. Alternatively, the system 2 may perform image analysis (e.g., detecting colors, textures, etc.) on avatars or other digital images (such as images of animated characters, celebrities, or social media influencers), and determine product recommendations based on the image analysis.

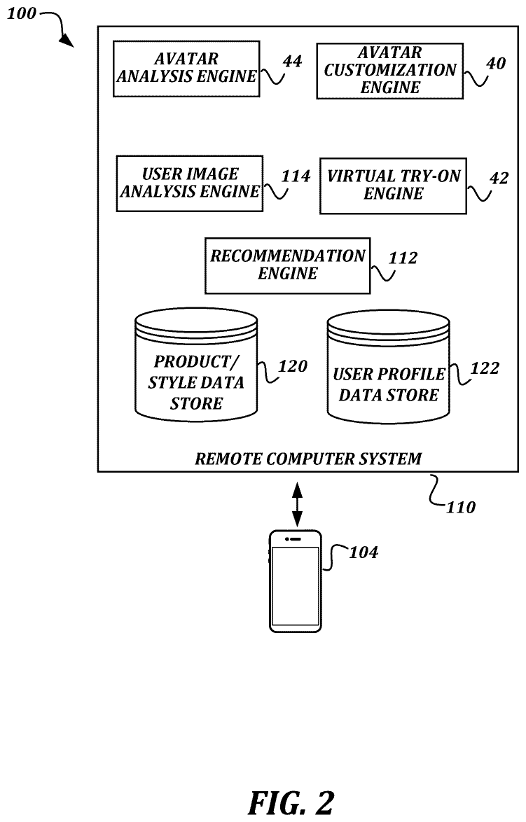

FIG. 2 is a block diagram that illustrates a system in which various aspects of the present disclosure may be implemented. In the illustrative arrangement depicted in FIG. 2, client computing device 104 connects to remote computer system 110, which may generate custom content for a user, such as avatar customizations, virtual try-on content, product recommendations, or style recommendations. Client computing device 104 or remote computer system 110 may also include or communicate with environmental sensors and/or other computing devices.

Client computing device 104 may be used by a consumer, a beauty/styling professional, or other entities to interact with other components of the system 100, such as remote computer system 110. In an embodiment, client computing device 104 is a mobile computing device such as a smart phone or a tablet computing device. However, any other suitable type of computing device capable of communicating via the network and presenting a user interface may be used, including but not limited to a desktop computing device, a laptop computing device, or a smart watch (or combinations of such devices).

Illustrative features and functionality of remote computer system 110 will now be described. Remote computer system 110 includes one or more server computers that implement the illustrated features, e.g., in a cloud computing arrangement. As illustrated in FIG. 2, the remote computer system 110 includes avatar customization engine 40, virtual try-on engine 42, avatar analysis engine 44, recommendation engine 112, user image analysis engine 114, product/style data store 120, and user profile data store 122. Recommendation engine 112 generates product or styling recommendations, which can then be transmitted to, e.g., client computing device 104 in the form of a style profile. The style profile may include, for example, styling routine recommendations, product recommendations, tutorials, or other information.

In an embodiment, recommendation engine 112 generates a style profile based on information received from product/style data store 120 along with user information from user profile data store 122, client computing device 104, or a combination thereof, or from some other source or combination of sources. In an embodiment, recommendation engine 112 receives a request for a new or updated recommendation from client computing device 104, obtains information from product/style data store 120 (e.g., available cosmetics, cosmetic applicators, hair styling devices, etc.), user profile data store 122 (e.g., users' answers to questions about themselves, device usage data, preferred colors or styles, location, age, products used, etc.), or client computing device 104 (e.g., information describing the user's current location, satisfaction with previous routines (indicated by e.g., star rating or number rating), etc.), and uses this information to perform further processing. In an embodiment, recommendation engine 112 uses information it obtains to, e.g., generate a style profile or update a previously defined style profile.

In some embodiments, user image analysis engine 114 includes one or more modules depicted in FIG. 1A or FIG. 1B, such as face detection module 10, image segmentation module 20, and/or attribute analysis module 30.

Avatar customization engine 40, virtual try-on engine 42, avatar analysis engine 44, user image analysis engine 114, and/or recommendation engine 112 may employ machine learning or artificial intelligence techniques (e.g., template matching, feature extraction and matching, classification, artificial neural networks, deep learning architectures, genetic algorithms, or the like). In an embodiment, to generate a custom product recommendation or style recommendation, recommendation engine 112 may analyze image data or other sensor data to determine, e.g., skin attributes, eye attributes, hair attributes (e.g., color, length, texture, porosity, etc.), or other attributes. In such a scenario, recommendation engine 112 may use such information to generate or modify a recommendation that suits the particular features of the user.

Described embodiments allow for different machine learning approaches, or combinations of approaches, to be employed, using one or more machine learning models. In an illustrative scenario, user image analysis engine 114 includes a first machine learning model for determining characteristics of the user's skin or hair, or other attributes of the user's appearance. The first machine learning model may be trained on a set of supervised training data comprising image data and/or other sensor data, as image data or other sensor data of hair of other users. For example, the first machine learning model may be trained to take extracted images of a user's hair or skin as input and to output an estimated skin tone or hair color based on training images of the skin or hair of other users, which may be labeled with known skin tones or hair colors. A second machine learning model may be used by avatar customization engine 40, and may be trained using training images or extracted attributes of various users that are labeled with corresponding avatar customization information (e.g., hair color, lip color, eyelash configurations, etc.). The labels corresponding to the avatar looks may be quantified by, e.g., assigning particular color values or contours to avatar features such as lips, hair, eyelids, eyelashes, etc. A third machine learning model may be used by recommendation engine 112 to generate recommendations based on self-reported or automatically determined user characteristics. For example, the third machine learning model may take user attributes and/or avatar attributes (or modified user images) as input and output recommended products or styles as output. Such parameters may be automatically detected or self-reported. In addition, the second machine learning model may take user preference information, trending style information, or other information as input to generate a recommendation.

In some embodiments, the machine learning models are neural networks, including but not limited to feedforward neural networks, convolutional neural networks (CNNs), recurrent neural networks, and generative adversarial networks (GANs). In some embodiments, any suitable training technique may be used, including but not limited to gradient descent, which may include stochastic, batch, and mini-batch gradient descent.

In an embodiment, location information may be used to look up and obtain other information which may be relevant to a recommendation. For example, client computing device 104 may obtain location information (e.g., via a Global Positioning System (GPS) unit) to a remote computer system 110, which may in turn obtain current environmental data (e.g., humidity information, temperature information, etc.) for the respective location. The remote computer system 110 may then use the environmental data to generate or modify a product or style recommendation. In an illustrative scenario, the remote computer system 110 uses location information to determine that the user is in a hot, humid city, and modifies a product recommendation (e.g., a cosmetic recommendation) to account for this environment in a way that may differ from a cool, dry environment but still allow the user to achieve a desired look that is represented on an avatar or digital image.

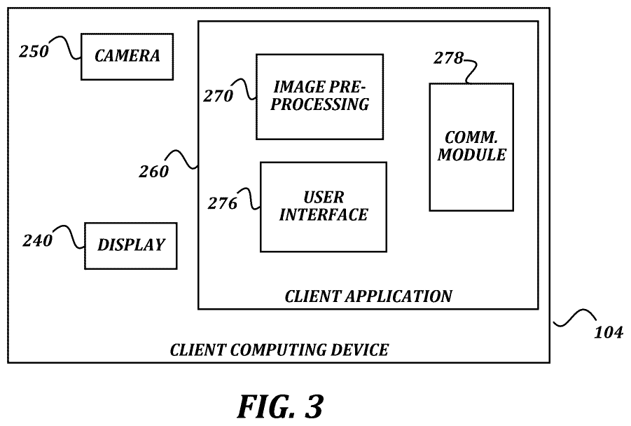

FIG. 3 is a block diagram that illustrates a non-limiting example embodiment of a client computing device 104 according to various aspects of the present disclosure. Client computing device 104 may be used to implement one or more aspects of system 1 or system 2, including all or some of the modules and functionality depicted in FIG. 1A or FIG. 1B, in any combination. In an illustrative scenario, client computing device 104 captures one or more digital images of a user via camera 250, transmits the image data to another computer system (such as a server computer system) for processing, receives modified image data, and implements user interface 276. Client computing device 104 may communicate with other computers or system using any suitable communication technology, such as wireless communication technologies including but not limited to WiFi, Wi-MAX, Bluetooth, 3G, 4G, 5G, and LTE; or wired communication technologies including but not limited to Ethernet, FireWire, and USB.

In the illustrated embodiment, client computing device 104 includes camera 250 and display 240 and runs client application 260, which includes image pre-processing engine 270, user interface 276, and communication module 278. User interface 276 may present different types of functionality to a user, such as guides, tutorials, or virtual “try-on” functionality for exploring new products or looks. This technology may, in some embodiments, allow users to virtually try different looks or products (e.g., lashes of different lengths, colors, thicknesses, finishes, etc., or related cosmetics such as mascara or eye shadow) by applying virtual lashes or cosmetics to 2D face images or a virtual 3D model of a user's face. This technology may use original user images or modified user images, which may be generated in accordance with embodiments described herein. In some embodiments, the user interface includes a graphical user interface to assist a user in obtaining high-quality original images on which the modified images may be based.

In some embodiments, image pre-processing engine 270 is configured to pre-process images, e.g., before they are transmitted to an image processing computer system. In some embodiments, image pre-processing engine 270 performs image normalization, which may include, for example, color correction, noise reduction or filtering; adjusting orientation; cropping; adjusting brightness/exposure; or adjusting contrast. In an illustrative scenario, an image includes an off-center face where an area of interest, such as the user's eyes, takes up only a small portion of the overall image. To allow for more accurate or photorealistic image modification, it may be desirable to reduce the area in the image that is not of interest. This may be accomplished by, for example, using a face detection algorithm to detect the portion of the image that depicts the eyes, centering the eyes within the image, and zooming in on the eyes to cause the eyes to occupy a larger portion of the image. Other possible normalization actions include cropping the image, reducing or increasing bit depth, undersampling or oversampling pixels of the image, or the like. The image data can then be sent (potentially along with other information, such as a user ID, device ID, or the like) to communication module 278 for subsequent formatting and transmission to an image processing system. (Other features of the client computing device 104 are not shown in FIG. 1B for ease of illustration.)

Many alternatives to the arrangements and usage scenarios depicted in FIGS. 1A, 1B, 2, and 3 are possible. For example, functionality described as being performed by client computing device 104 may instead be performed by a server computer system, or vice versa, or such functionality may be performed by different devices or systems. As another example, functionality described as being performed by a particular module or component may instead be performed by a combination of such modules or components, or by a different module or component, or functionality described as being performed by individual modules or components may be combined in a single module or component.

Within components of the system or devices depicted in FIG. 1A, 1B, 2, or 3, or by components of such systems and devices working in combination, numerous technical benefits are achieved. For example, the ability to automatically generate avatar customizations or virtual try-on content using techniques described herein overcomes technical limitations of other techniques, such as storing corresponding avatar/user value pairs in lookup tables, which have significant limitations in terms of large storage needs. As another example, the systems and devices allow some aspects of described embodiments to be implemented independently by client computing devices, while moving other processing burdens to the remote computer system 110 (which may be a relatively high-powered and reliable computing system), thus improving performance and preserving battery life for functionality provided by client computing devices.

In general, the word “engine,” as used herein, refers to logic embodied in hardware or software instructions written in a programming language, such as C, C++, COBOL, JAVA™, PHP, Perl, HTML, CSS, Javascript, VBScript, ASPX, Microsoft.NET™, and/or the like. An engine may be compiled into executable programs or written in interpreted programming languages. Software engines may be callable from other engines or from themselves. Generally, the engines described herein refer to logical modules that can be merged with other engines or divided into sub-engines. The engines can be stored in any type of computer-readable medium or computer storage device and be stored on and executed by one or more general purpose computers, thus creating a special purpose computer configured to provide the engine or the functionality thereof.

As understood by one of ordinary skill in the art, a “data store” as described herein may be any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, as described further below. One of ordinary skill in the art will recognize that separate data stores described herein may be combined into a single data store, and/or a single data store described herein may be separated into multiple data stores, without departing from the scope of the present disclosure.

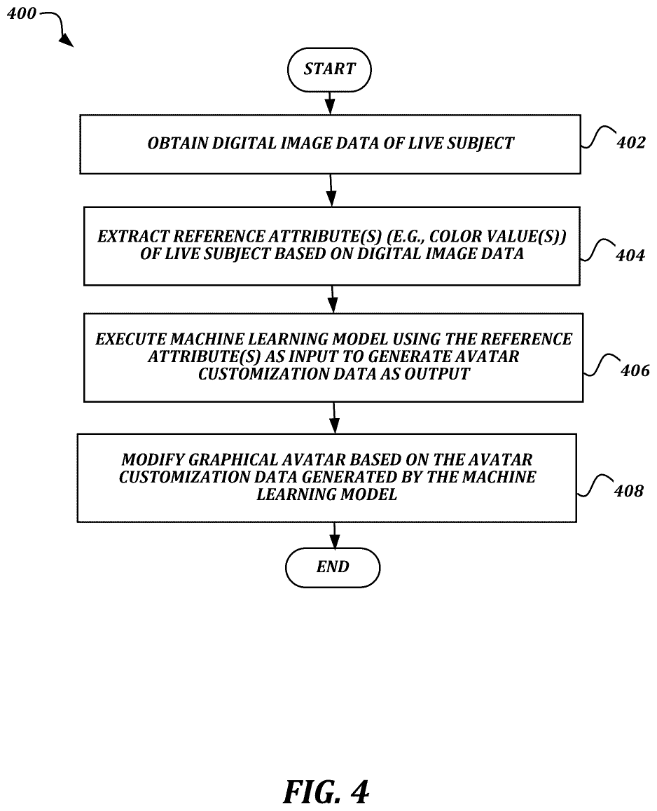

FIG. 4 is a flowchart that illustrates an example embodiment of a method of modifying a graphical avatar based on avatar customization data generated by a machine learning model. As illustrated, the method 400 is implemented by a computer system. The method 400 may be implemented by a server computer system including features of remote computer system 110, by client computing device 104, or a combination thereof, or by some other computing device or system.

From a start block, the method 400 proceeds to block 402, where the computer system obtains digital image data of a live subject (e.g., digital image data of a face area of the live subject). The method 400 proceeds to block 404, where the computer system extracts one or more reference attributes (e.g., color values) of the live subject based on the digital image data. The method proceeds to step 406, where the computer system executes a machine learning model using the reference attribute(s) as input to generate avatar customization data as output. In some embodiments, the machine learning model is trained on a training set of images using a supervised learning approach. In an illustrative embodiment, the training set of user images is labeled with corresponding avatar attributes. In an illustrative scenario, the reference attribute(s) comprise a first set of hexadecimal color values, and the avatar customization data generated by the machine learning model comprises a second set of hexadecimal color values. The method proceeds to step 408, where the computer system modifies or generates a graphical avatar based on the avatar customization data generated by the machine learning model.

The technique illustrated in FIG. 4 can be used in a variety of scenarios. In one illustrative scenario relating to hair color, the reference attribute(s) comprise a hair color value of the live subject, the machine learning model uses the hair color value of the live subject as input to generate the avatar customization data, and the avatar customization data comprises one or more avatar hair color values.

In another illustrative scenario relating to face color (e.g., eye color, skin tone, or cosmetic color), the reference attribute(s) comprise a face color value of the live subject, the avatar customization data comprises an avatar face color value, modifying the graphical avatar based on the avatar customization data comprises modifying a face area of the graphical avatar based on the avatar face color value, and the modified face area of the graphical avatar corresponds to the face area of the live subject. In an illustrative cosmetic scenario, the face color value of the live subject corresponds to a cosmetic worn on the face area of the live subject, and the modified face area of the graphical avatar includes a depiction of the cosmetic applied to the modified face area of the graphical avatar.

In another illustrative scenario relating to texture, the reference attribute(s) include a live texture value of the face area of the live subject. For example, in an illustrative scenario involving cosmetics, the modified face area of the graphical avatar includes a depiction of a cosmetic applied to the modified face area of the graphical avatar, the depicted cosmetic having a texture or finish based on the avatar texture customization data. Further operations relating to texture may be performed in place of or in combination with operations relating to color values or other values. For example, in a situation where a graphical avatar has been previously modified based on color values of the live subject, such operations can include executing a machine learning model using the live texture value of a face area of the live subject as input to generate avatar texture customization data as output; and, by the avatar customization engine, further modifying the graphical avatar based on the avatar texture customization data, such as by modifying a face area of the graphical avatar based on the avatar texture customization data, wherein the modified face area of the graphical avatar corresponds to the face area of the live subject.

In another illustrative scenario relating to hair, the digital image data of the live subject comprises digital image data of hair of the live subject, and the reference attribute(s) include length, texture, or style of hair of the live subject. Further operations relating to hair length, texture, or style may be performed in place of or in combination with operations relating to color values of skin, cosmetics, or hair, or other values, such as texture of skin or cosmetics. For example, in a situation where a graphical avatar has been previously modified based on color values of the live subject, such operations can include executing a machine learning model using the length, texture, or style of the hair of the live subject as input to generate avatar hair customization data as output, and by the avatar customization engine, further modifying the graphical avatar based on the avatar hair customization data.

In another illustrative scenario relating to eyelashes, the digital image data of the live subject comprises digital image data of eyelashes of the live subject, and the reference attribute(s) include length, density, color, or texture of eyelashes of the live subject. Further operations relating to length, density, color, or texture of eyelashes may be performed in place of or in combination with operations relating to color values of skin, cosmetics, or hair, or operations relating to other values, such as texture of skin or cosmetics, or length, texture, or style of hair. Such further operations can include executing a machine learning model using the length, density, color, or texture of the eyelashes of the live subject as input to generate avatar lash customization data as output, and by the avatar customization engine, further modifying the graphical avatar based on the avatar lash customization data.

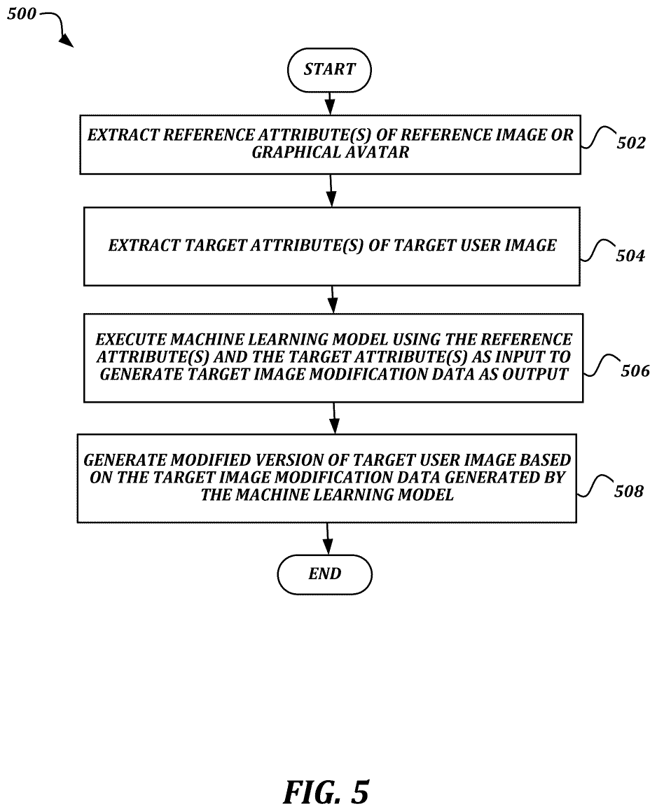

FIG. 5 is a flowchart that illustrates an example embodiment of a method of generating a modified version of a user image based on a reference image or graphical avatar. As illustrated, the method 500 is implemented by a computer system. The method 500 may be implemented by a server computer system including features of remote computer system 110, by client computing device 104, or a combination thereof, or by some other computing device or system.

From a start block, the method 500 proceeds to block 502, where the computer system extracts one or more reference attributes of a reference image or graphical avatar. The method 500 proceeds to block 504, where the computer system extracts one or more target attributes of one or more target user images. The method proceeds to step 506, where the computer system executes a machine learning model using the reference attribute(s) and the target attribute(s) as input to generate target image modification data as output. In some embodiments, the machine learning model is trained on a training set of modified user images using a supervised learning approach. In an illustrative embodiment, the training set of modified user images is labeled with corresponding avatar attributes. In an illustrative scenario, the reference attribute(s) comprise a first set of hexadecimal color values, and the target image modification data generated by the machine learning model comprises a second set of hexadecimal color values, which may be used to modify the target user image. The method proceeds to step 508, where the computer system generates a modified version of the target user image(s) based on the target user image modification data generated by the machine learning model. The modified version of the target user image(s) may include modifications of target attributes extracted from the target user image(s).

The technique illustrated in FIG. 5 can be used in a variety of scenarios. In one illustrative scenario relating to hair color, the reference attribute(s) comprise one or more hair color values of a graphical avatar, the machine learning model uses the hair color value(s) of the graphical avatar as input to generate the target image modification data, and the target image modification data comprises one or more modified hair color values for the target user image.

In another illustrative scenario relating to face color (e.g., eye color, skin tone, or cosmetic color), the reference attribute(s) comprise a face color value of the reference image or graphical avatar, and generating the modified version of the target user image comprises modifying a face area of the target user image based on the face color value of the reference image or graphical avatar. In an illustrative cosmetic scenario, the modified version of the target user image includes a depiction of a virtual cosmetic applied to the modified face area of the target user image, wherein a color of the virtual cosmetic corresponds to the face color value of the reference image or graphical avatar.

In another illustrative scenario relating to texture, the reference attribute(s) comprise a texture value of the reference image or graphical avatar. For example, in an illustrative scenario involving cosmetics, the modified face area of the target user image includes a depiction of a virtual cosmetic applied to the modified face area of the target user image, the depicted virtual cosmetic having a texture or finish based on the target image texture modification data. Further operations relating to texture may be performed in place of or in combination with operations relating to color values or other values. For example, such operations can include executing a machine learning model using the texture value of the reference image or graphical avatar as input to generate target image texture modification data as output, and by the virtual try-on engine, further modifying the target user image based on the target image texture modification data by modifying a face area of the target user image based on the target image texture modification data.

In another illustrative scenario relating to hair, the reference attribute(s) of the reference image or graphical avatar comprise length, texture, or style of hair of the reference image or graphical avatar. Further operations relating to hair length, texture, or style may be performed in place of or in combination with operations relating to color values of skin, cosmetics, or hair, or other values, such as texture of skin or cosmetics. For example, such operations can include executing a machine learning model using the length, texture, or style of the hair of the reference image or graphical avatar as input to generate target image hair modification data as output, and by the virtual try-on engine, further modifying the target user image based on the target image hair modification data.

In another illustrative scenario relating to eyelashes, the reference attribute(s) of the reference image or graphical avatar comprise length, density, color, or texture of eyelashes of the reference image or graphical avatar. Further operations relating to length, density, color, or texture of eyelashes may be performed in place of or in combination with operations relating to color values of skin, cosmetics, or hair, or operations relating to other values, such as texture of skin or cosmetics, or length, texture, or style of hair. Such further operations can include executing a machine learning model using the length, density, color, or texture of eyelashes of the reference image or graphical avatar as input to generate target image eyelash modification data as output, and by the virtual try-on engine, further modifying the target user image based on the target image eyelash modification data.

In some embodiments, the computer system presents in a user interface a product or style recommendation based on the one or more reference attributes, the target image modification data, the modified version of the target user image, or a combination thereof, such as in the illustrative virtual try-on user interface shown in FIG. 1B.

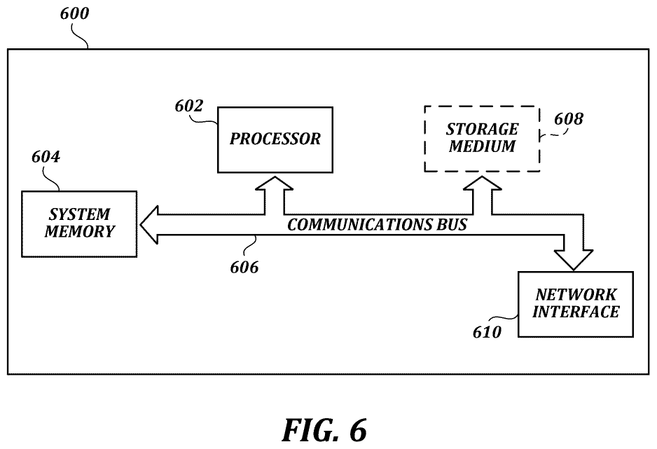

FIG. 6 is a block diagram that illustrates aspects of an exemplary computing device 600 appropriate for use as a computing device of the present disclosure. While multiple different types of computing devices were discussed above, the exemplary computing device 600 describes various elements that are common to many different types of computing devices. While FIG. 6 is described with reference to a computing device that is implemented as a device on a network, the description below is applicable to servers, personal computers, mobile phones, smart phones, tablet computers, embedded computing devices, and other devices that may be used to implement portions of embodiments of the present disclosure. Moreover, those of ordinary skill in the art and others will recognize that the computing device 600 may be any one of any number of currently available or yet to be developed devices.

In its most basic configuration, the computing device 600 includes at least one processor 602 and a system memory 604 connected by a communication bus 606.

Depending on the exact configuration and type of device, the system memory 604 may be volatile or nonvolatile memory, such as read only memory (“ROM”), random access memory (“RAM”), EEPROM, flash memory, or similar memory technology. Those of ordinary skill in the art and others will recognize that system memory 604 typically stores data and/or program modules that are immediately accessible to and/or currently being operated on by the processor 602. In this regard, the processor 602 may serve as a computational center of the computing device 600 by supporting the execution of instructions.

As further illustrated in FIG. 6, the computing device 600 may include a network interface 610 comprising one or more components for communicating with other devices over a network. Embodiments of the present disclosure may access basic services that utilize the network interface 610 to perform communications using common network protocols. The network interface 610 may also include a wireless network interface configured to communicate via one or more wireless communication protocols, such as WiFi, 2G, 3G, 4G, LTE, 5G, WiMAX, Bluetooth, Bluetooth low energy, and/or the like. As will be appreciated by one of ordinary skill in the art, the network interface 610 illustrated in FIG. 6 may represent one or more wireless interfaces or physical communication interfaces described and illustrated above with respect to particular components of the system 100.

In the exemplary embodiment depicted in FIG. 6, the computing device 600 also includes a storage medium 608. However, services may be accessed using a computing device that does not include means for persisting data to a local storage medium. Therefore, the storage medium 608 depicted in FIG. 6 is represented with a dashed line to indicate that the storage medium 608 is optional. In any event, the storage medium 608 may be volatile or nonvolatile, removable or nonremovable, implemented using any technology capable of storing information such as, but not limited to, a hard drive, solid state drive, CD ROM, digital versatile disk (DVD), or other disk storage, magnetic cassettes, magnetic tape, magnetic disk storage, and/or the like.

As used herein, the term “computer-readable medium” includes volatile and non-volatile and removable and non-removable media implemented in any method or technology capable of storing information, such as computer readable instructions, data structures, program modules, or other data. In this regard, the system memory 604 and storage medium 608 depicted in FIG. 6 are examples of computer-readable media.

Suitable implementations of computing devices that include a processor 602, system memory 604, communication bus 606, storage medium 608, and network interface 610 are known and commercially available. For ease of illustration and because it is not important for an understanding of the claimed subject matter, FIG. 6 does not show some of the typical components of many computing devices. In this regard, the computing device 600 may include input devices, such as a keyboard, keypad, mouse, microphone, touch input device, touch screen, tablet, and/or the like. Such input devices may be coupled to the computing device 600 by wired or wireless connections including radio frequency (RF), infrared, serial, parallel, Bluetooth®, Bluetooth® low energy, USB, or other suitable connections protocols using wireless or physical connections. Similarly, the computing device 600 may also include output devices such as a display, speakers, printer, etc.

While illustrative embodiments have been illustrated and described, it will be appreciated that various changes can be made therein without departing from the spirit and scope of the invention.

The embodiments of the invention in which an exclusive property or privilege is claimed are defined as follows:

1. A non-transitory computer-readable medium having stored thereon instructions configured to, when executed by one or more computing devices of a computer system, cause the computer system to perform operations comprising:
extracting, by a reference analysis engine, one or more reference attributes of a reference image or graphical avatar;
extracting, by a user image analysis engine, one or more target attributes of a target user image;
executing a machine learning model using the one or more reference attributes and the one or more target attributes as input to generate target image modification data as output; and
generating, by a virtual try-on engine, a modified version of the target user image based on the target image modification data generated by the machine learning model.

2. The non-transitory computer-readable medium of claim 1, wherein the machine learning model is trained on a training set of modified user images using a supervised learning approach.

3. The non-transitory computer-readable medium of claim 2, wherein the training set of modified user images is labeled with corresponding avatar attributes.

4. The non-transitory computer-readable medium of claim 3, wherein the one or more reference attributes comprise a first set of hexadecimal color values, and wherein the target image modification data generated by the machine learning model comprises a second set of hexadecimal color values.

5. The non-transitory computer-readable medium of claim 1, wherein the one or more reference attributes comprise one or more hair color values of a graphical avatar, wherein the machine learning model uses the one or more hair color values of the graphical avatar as input to generate the target image modification data, and wherein the target image modification data comprises one or more modified hair color values for the target user image.

6. The non-transitory computer-readable medium of claim 1, wherein the one or more reference attributes comprise a face color value of the reference image or graphical avatar, and wherein generating the modified version of the target user image comprises modifying a face area of the target user image based on the face color value of the reference image or graphical avatar.

7. The non-transitory computer-readable medium of claim 6, wherein the modified version of the target user image includes a depiction of a virtual cosmetic applied to the modified face area of the target user image, wherein a color of the virtual cosmetic corresponds to the face color value of the reference image or graphical avatar.

8. The non-transitory computer-readable medium of claim 1, wherein the one or more reference attributes comprise a texture value of the reference image or graphical avatar, the operations further comprising:
executing a machine learning model using the texture value of the reference image or graphical avatar as input to generate target image texture modification data as output; and
by the virtual try-on engine, further modifying the target user image based on the target image texture modification data by modifying a face area of the target user image based on the target image texture modification data.

9. The non-transitory computer-readable medium of claim 8, wherein the modified face area of the target user image includes a depiction of a virtual cosmetic applied to the modified face area of the target user image, the depicted virtual cosmetic having a texture or finish based on the target image texture modification data.

10. The computer-readable medium of claim 1, wherein the one or more reference attributes of the reference image or graphical avatar comprise length, texture, or style of hair of the reference image or graphical avatar, the operations further comprising:
executing a machine learning model using the length, texture, or style of the hair of the reference image or graphical avatar as input to generate target image hair modification data as output; and
by the virtual try-on engine, further modifying the target user image based on the target image hair modification data.

11. The computer-readable medium of claim 1, wherein the one or more reference attributes of the reference image or graphical avatar comprise length, density, color, or texture of eyelashes of the reference image or graphical avatar, the operations further comprising:
executing a machine learning model using the length, density, color, or texture of eyelashes of the reference image or graphical avatar as input to generate target image eyelash modification data as output; and
by the virtual try-on engine, further modifying the target user image based on the target image eyelash modification data.

12. A computer-implemented method executed by one or more computing devices of a computer system, the method comprising:
extracting, by a reference analysis engine, one or more reference attributes of a reference image or graphical avatar;
extracting, by a user image analysis engine, one or more target attributes of a target user image;
executing a machine learning model using the one or more reference attributes and the one or more target attributes as input to generate target image modification data as output; and
generating, by a virtual try-on engine, a modified version of the target user image based on the target image modification data generated by the machine learning model.

13. The method of claim 12, wherein the machine learning model is trained on a training set of modified user images using a supervised learning approach, and wherein the training set of modified user images is labeled with corresponding avatar attributes.

14. The method of claim 13, wherein the one or more reference attributes comprise a first set of hexadecimal color values, and wherein the target image modification data generated by the machine learning model comprises a second set of hexadecimal color values.

15. The method of claim 12, wherein the one or more reference attributes comprise one or more hair color values of a graphical avatar, wherein the machine learning model uses the one or more hair color values of the graphical avatar as input to generate the target image modification data, and wherein the target image modification data comprises one or more modified hair color values for the target user image.

16. The method of claim 12, wherein the one or more reference attributes comprise a face color value of the reference image or graphical avatar, wherein generating the modified version of the target user image comprises modifying a face area of the target user image based on the face color value of the reference image or graphical avatar, wherein the modified version of the target user image includes a depiction of a virtual cosmetic applied to the modified face area of the target user image, and wherein a color of the virtual cosmetic corresponds to the face color value of the reference image or graphical avatar.

17. The method of claim 12, wherein the one or more reference attributes comprise a texture value of the reference image or graphical avatar, the method further comprising:
executing a machine learning model using the texture value of the reference image or graphical avatar as input to generate target image texture modification data as output; and
by the virtual try-on engine, further modifying the target user image based on the target image texture modification data by modifying a face area of the target user image based on the target image texture modification data,
wherein the modified face area of the target user image includes a depiction of a virtual cosmetic applied to the modified face area of the target user image, the depicted virtual cosmetic having a texture or finish based on the target image texture modification data.

18. The method of claim 12, wherein the one or more reference attributes of the reference image or graphical avatar comprise length, texture, or style of hair of the reference image or graphical avatar, the method further comprising:
executing a machine learning model using the length, texture, or style of the hair of the reference image or graphical avatar as input to generate target image hair modification data as output; and
by the virtual try-on engine, further modifying the target user image based on the target image hair modification data.

19. The method of claim 12, wherein the one or more reference attributes of the reference image or graphical avatar comprise length, density, color, or texture of eyelashes of the reference image or graphical avatar, the method further comprising:
executing a machine learning model using the length, density, color, or texture of eyelashes of the reference image or graphical avatar as input to generate target image eyelash modification data as output; and
by the virtual try-on engine, further modifying the target user image based on the target image eyelash modification data.

20. The method of claim 12 further comprising presenting in a user interface a product or style recommendation based on the one or more reference attributes, the target image modification data, the modified version of the target user image, or a combination thereof.
